(19) United States
(12) Patent Application Publication
(10) Pub. No.: US 2024/0396950 A1
(43) Pub. Date: Nov. 28, 2024

(54) SYSTEMS AND METHODS FOR TELEPHONY NETWORK MANAGEMENT

(71) Applicant: Comcast Cable Communications, LLC, Philadelphia, PA (US)

(72) Inventors: Tamika DAVIS, Aurora, CO (US); Levani ZANDARASHVILI, Philadelphia, PA (US); Joshua JACKSON, Havertown, PA (US); Rama MAHAJANAM, Wayne, PA (US)

(21) Appl. No.: 18/324,626

(22) Filed: May 26, 2023

(51) Int. Cl. H04L 65/1069

(52) U.S. Cl. CPC H04L 65/1069

(57) ABSTRACT

Methods and systems for telephony traffic analysis and resource optimization are described herein. A computing device of a telephony network, such as a load balancer, may receive a request for connecting a call originating from outside the telephony network. Based on characteristics of the request, such as an originating call number, a destination call number, and the like, the computing device may determine a probability the call request may be completed by the telephony network. If the probability falls below a predefined threshold, the computing device may reject the call request. Thus, the call request may not be routed through the telephony network for connection attempts. This may save network resources from unnecessary waste, and may free the network to route calls with a higher chance of successful connections.

### BACKGROUND

In a telephony network, outbound telephone calls may be serviced by session border controllers (SBCs) that allocate resources to handle the voice media data and control signaling associated with each voice call. The SBCs may work in conjunction with a routing engine to determine the most economical means for routing calls to their destinations. For example, a service provider may have a choice between using internal pathways and using call capacity offered by another service provider to terminate call, and each option may have unique associated costs.

Unfortunately, not all calls may be connected, which may result in wasted resources of the telephony network. For example, many of the calls coming in to an SBC may be dialed at random by the caller, and may therefore be more prone to being directed to numbers which are not in service. Further, typically telephony networks may attempt to successfully connect a call before ultimately terminating the request to connect. For example, the SBC may route the call through multiple call routes until the unsuccessful attempts reach a predefined threshold. This may compound a waste of network resources.

### SUMMARY

Methods and systems for telephony traffic analysis and resource optimization are described herein. A computing device of a telephony network, such as a load balancer, may receive a request for connecting a call originating from outside the telephony network. Based on characteristics of the request, such as an originating call number, a destination call number, and the like, the computing device may determine a probability the call request may be completed by the telephony network. If the probability falls below or does not satisfy a predefined threshold, the computing device may reject the call request. Thus, the call request may not be routed through the telephony network for connection attempts. This may save network resources from unnecessary waste, and may free the network to route calls with a higher chance of successful connections.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

These and other features, aspects, and advantages of the present disclosure will become better understood with regard to the following description, claims, and drawings. The present disclosure is presented by way of example, and not limited by, the accompanying drawings in which like numerals indicate similar elements.

FIG. 1 shows an example telephony network.

FIG. 2 shows an example configuration for a system.

FIG. 3 shows data for training and testing a system.

FIG. 4 shows an example computing device.

FIG. 5 shows an example method.

FIG. 6 shows an example method.

FIG. 7 shows an example method.

### DETAILED DESCRIPTION OF ILLUSTRATIVE EMBODIMENTS

A system may generate a trained model for determining a likelihood that a call request received by the system may be successfully completed to a live answer or voicemail. Characteristics such as source number, destination number, time, date, success rates for call requests, number of attempted vendors or routes, call length, post-dial delay, geography, and the like, may be inputted as training parameters.

When a request to connect a telephony call comes into a telephony network, characteristics associated with the request may be inputted into the trained model to determine a probability the call may be completed. If the probability value falls below or does not satisfy a probability threshold, the system may reject or terminate the call request as opposed to forwarding the call further through the telephony network. In some cases, the trained model may determine an estimated number of routing attempts to successfully complete the call. If the estimated number of attempts exceeds or satisfies an attempt threshold, the system may reject or terminate the call request as opposed to forwarding the call further through the telephony network. Rejecting the call request may save network resources, particularly in cases where the telephony network is operating at maximum or near-maximum capacity.

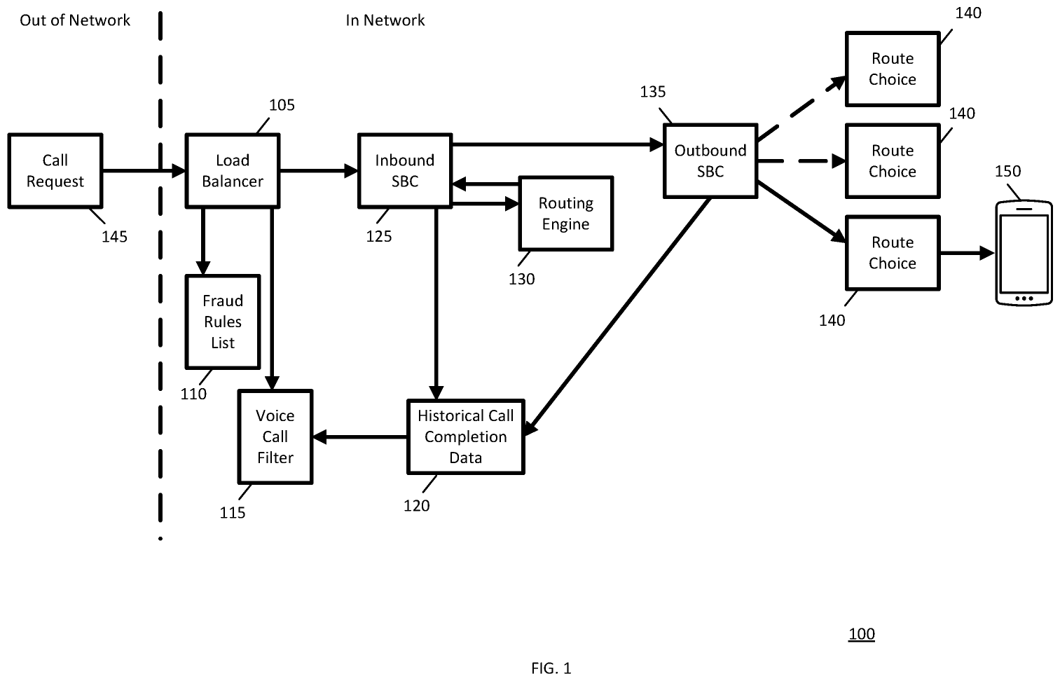

FIG. 1 is an example of a telephony network 100 on which many of the various features described herein may be implemented. The telephony network 100 may include a load balancer 105, a fraud rules list 110, a voice call filter 115, historical call completion data 120, an inbound session border controller (SBC) 125, a routing engine 130, an outbound SBC 135, and routing choices 140. It should be noted while the singular terms are included herein, it is contemplated that some devices or entities of the telephony network 100 may be implemented as one or more devices or entities. For example, the load balancer 105, the fraud rules list 110, the voice call filter 115, the historical call completion data 120, the SBC 125, the routing engine 130, the outbound SBC 135, and the routing choices 140 may be implemented as one or more computing devices. Further, any device disclosed herein may be implemented using one or more computing nodes, such as virtual machines, executed on a single device or multiple devices.

The devices and entities of the telephony network 100 may communicate with one another via one or more communication protocols. The telephony network may include fiber, cable, or a combination thereof. In some cases, the telephony network 100 may include wire links, wireless links, or a combination thereof. In some cases, the telephony network 100 may also include routers, switches, nodes, gateways, servers, modems, and the like, for further facilitating communication between the entities of the network 100 and end devices.

A call attempt request 145 may originate with a source user device (not shown). The source user device may include a user device, such as a landline telephone, a smart phone, a desktop, a laptop, a portable computing device, a mobile computing device, a stationary computing device, a wearable computing device, etc. The source user device may include and/or be associated with a first user identifier. The first user identifier may include a number, such as a phone number. The first user identifier may include an address, such as a media access control address (MAC address) and/or an IP address. The source user device may be associated with an entity, such as a subscriber to a service.

The load balancer 105 may receive call requests from external to the telephony network 100. The load balancer may be able to forward the call attempt request to other entities of the telephony network 100, such as the inbound SBC 125. In some cases, the load balancer 105 may analyze the call request, current conditions of the telephony network 100, and the like, to forward the call request to a selected entity. For example, in some cases, the telephony network 100 may include multiple inbound SBCs 125. The load balancer 105 may analyze the conditions of the inbound SBCs 125, and associated routes, to select a particular inbound SBC 125 to forward the call request to. For example, the load balancer 105 may determine that a first inbound SBC is operating near capacity, whereas a second inbound SBC is operating with room for additional capacity. In this scenario, the load balancer 105 may select, and forward the call request, to the second inbound SBC.

In some cases, the load balancer 105 may also filter call requests. For example, the load balancer 105 may be in communication, or have access to, a fraud rules list 110. The fraud rules list 110 may include, for example, a blacklist of numbers which the load balancer 105 may block call requests from. For example, a list entry may include an identifier of a source device. For example, the identifier may include a part of, or the entire, phone number associated with a source device. In another example, the identifier may include a part of, or the entire, an Internet Protocol (IP) address of the source device. When the load balancer 105 receives a request for connecting a call, the load balancer 105 may access the fraud rules list 110 to determine whether the identifier for the source device matches any entries in the fraud rules list 110. If a match exists, the load balancer 105 may terminate or reject the call request (e.g., based on identifying the source device as a potential spam or fraud device).

The inbound SBC 125 and outbound SBC 135 may assist in managing the incoming call request, establishing a session for the call, and provide security for the network 100. For example, particular functions of the inbound SBC 125 and the outbound SBC 135 may include protecting the network 100 from fraudulent activity, such as preventing Denial of Service attacks; converting communication protocols for the session, and routing the session from endpoint to endpoint. In some cases, the inbound SBC 125 may request a route for the call request from the routing engine 130. The routing engine 130 can, based on various parameters of the network 100, determine a route for the call request to pass through. For example, parameters such as operating conditions of the entities of the network 100, capacity or bandwidth related to the inbound SBC 125, outbound SBC 135, and route choices 140, may be relied on by the routing engine 130 to select a particular pathway for the request. The routing engine 130 may send the route (e.g., a SIP 302 route) to the inbound SBC 125. Based on the route, the inbound SBC 125 may forward the call signaling associated with the call attempt request to the outbound SBC 135. The outbound SBC 135 may send the call signaling to a route choice 140, which may forward the call signaling to the destination user device 150.

The call signaling may be directed to a destination user device 150. The destination user device 150 may include a user device, such as a landline telephone, a smart phone, a desktop, a laptop, a portable computing device, a mobile computing device, a stationary computing device, a wearable computing device, etc. The destination user device 150 may include and/or be associated with a second user identifier. The second user identifier may include a number, such as a phone number. The second user identifier may include an address, such as a MAC address and/or an IP address. The destination user device 150 may be associated with an entity, such as a subscriber to a service.

In some cases the call signaling may result in a successful call. A successful completed call may include a user answering the destination device 150, the call going to a voicemail, and the like. In other cases, the call signaling may fail to result in a successful call. A failed call may include a disconnected user device (e.g., a disconnected line), a nonexistent user device (e.g., a nonexistent line), an unanswered user device (e.g., a continuous ringing on the line), and the like.

In cases where call signaling results in a failed call, resources are wasted within the network 100. For example, the processes described with respect to the inbound SBC 125, the routing engine 130, the outbound SBC 135 and the routes 140, may include processing and memory resources that may be allocated towards a different call attempt request. Telephony networks, such as network 100, typically operate at capacity or near capacity, such that a failed call attempt may utilize resources that the network 100 could have reallocated towards a successful call not attempted. Further, in some cases, the network 100 may attempt another route for the call request, which may further exacerbate the resource waste usage, particularly in cases where further attempted routes also result in a failed call.

According to the present disclosure, the load balancer 105 may be configured to determine various characteristics of a call request, and may filter the call attempt request based on a probability the call attempt may result in a successful call. For example, the load balancer 105 may receive the call attempt request 145. The call attempt request 145 may include a variety of characteristics, parameters, and the like, associated with the call attempt. For example, the call attempt request 145 may include an identifier of the source device. For example, the call attempt request 145 may include a phone number of the source device, an IP address of the source device, and the like. In some cases, the call attempt request 145 may include an identifier for the destination device (e.g., device 150). For example, the call attempt request 145 may include a phone number of the destination device, an IP address of the destination device, and the like.

The load balancer 105 may access a voice call filter 115. The voice call filter 115 may include a model configured to determine a probability the call attempt request 145 may result in a successful call. In some cases, the voice call filter 115 may receive the characteristics from the load balancer 105, from other entities of the network (e.g., date and time characteristics, historical call data, etc.), and the like. The voice call filter 105 may input the characteristics into the trained model and generate a probability value corresponding to whether the call attempt request 145 may result in a successful call.

The characteristics associated with the call attempt request 145 may include a variety of information. For example, the characteristics may include the identifiers for the respective source device and destination device. In some cases, the characteristics may include regional data such as geography of the source device and/or destination device, jurisdiction of the source device and/or the destination device, availability of different vendors for attempting the call (e.g., via the routes 140), vendor characteristics (e.g., average completion rate for a time window, average call length for a time window, average post-dial delay for a time window, and the like). In some cases, the characteristics may include time and date information, such as day, month, year; time of call attempt request reception or generation; weekend or weekday; morning, afternoon, evening, night; and the like.

The probability value may be compared to a predefined probability threshold. For example, the probability threshold may be user-defined. In some cases, the probability threshold may be semi-dynamic, such that the threshold may switch between probability values (e.g., of a range) based on parameters or conditions of the network (e.g., current capacity, bandwidth, and the like), time, date, and the like. In some cases, the voice call filter 115 may send the probability value to the load balancer 105 for comparison (e.g., for the load balancer to determine whether to reject the call attempt request 145). In some cases, the voice call filter 115 may perform the comparison, and may inform the load balancer 105 of the result, or instruct the load balancer 105 to reject or accept the call attempt request 145.

In some cases, the probability value may be associated with whether the call may be completed within a number of call attempts. For example, the probability value may be associated with one attempt at completing the call (e.g., via one route 140). In some cases, the probability value may be associated with two or more attempts at completing the call (e.g., two or more routes 140). In some cases, the probability value may be associated with an unlimited number of call attempts.

Alternatively, the trained model of the voice call filter 115 may be configured to determine an estimated number of attempts to successfully complete the call. For example, the trained model may output a value (e.g., 2 attempts, 4 attempts, etc.) associated with an estimated number of attempts for successfully completing the call.

If the probability value falls below or does not satisfy the probability threshold, the load balancer 105 may reject the call attempt request 145. For example, the load balancer 105 may refrain from forwarding the call attempt request 145, the associated call signaling, and the like, to the inbound SBC 125. In some cases, the load balancer 105 may send a communication to the source device indicating the call rejection. In some cases, the load balancer 105 may notify other entities of the network 100 of the rejection, for example, the historical call completion data 120 (e.g., for future training of the model of the voice call filter 115, or another model).

Alternatively, if the probability value exceeds or satisfies the probability threshold, the load balancer 105 may forward the call attempt request 145 to the inbound SBC 125. In some cases, forwarding the call attempt request 145 may also include information for the inbound SBC 125 to generate a communication session for the source device and the destination device 150. The forwarded call attempt request 145 may follow the process for attempting the call as further described above. Likewise, in cases where the trained model of the voice call filter 115 generates an estimated number of call attempts, the predefined threshold may be associated with a number of call attempts. For example, in these cases the predefined threshold may be three call attempts. In these cases, the load balancer 105 may reject the call attempt request if the estimated number of call attempts exceeds or satisfies the call attempt threshold.

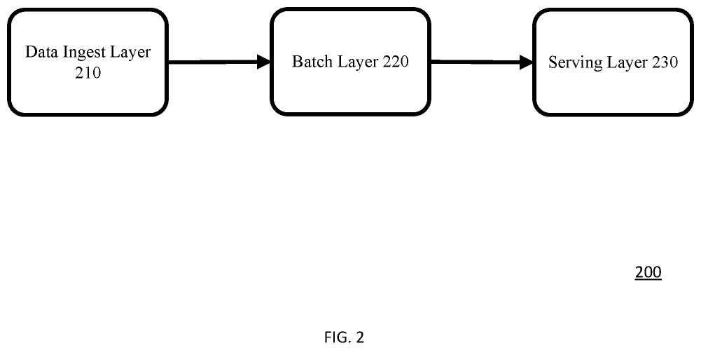

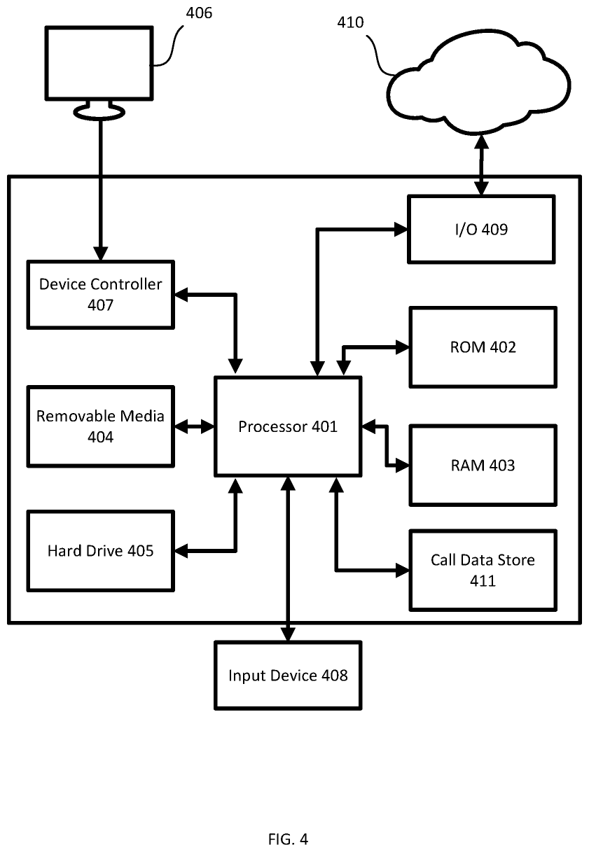

FIG. 2 shows an example configuration 200 which may be used in implementing one or more aspects described herein regarding generating probability values for whether a call attempt request will result in a successful call. The configuration 200 may be implemented in a telephony network such as that shown in FIG. 1. For example, the configuration 200 may be included in a voice call filter 115. The configuration 200 may include a data ingest layer 210, a batch layer 220, and a serving layer 230. The layers and modules that make up the software architecture of configuration 200 may be implemented by one or more computing devices, such as computing device 400 as shown in FIG. 4.

The data ingest layer 210 may be configured to retrieve, process, and/or store characteristics of call data for call attempts and entities in a telephone network (e.g., network 100). For example, the characteristics may include the identifiers for the respective source device and destination device. In some cases, the characteristics may include regional data such as geography of the source device and/or destination device, jurisdiction (local call, intra-state call, inter-state call, etc.) of the source device and/or the destination device, availability of different vendors for attempting the call (e.g., via the routes 140), vendor characteristics (e.g., completion rates, call lengths, post-dial delays, etc.), and the like. In some cases, the characteristics may include time and date information, such as day, month, year; time of call attempt request reception or generation; weekend or weekday; morning, afternoon, evening, night; and the like. In some cases, the characteristics may include destination unavailable data, such a 404 call counts and 404 call percentage. In some cases, the characteristics may also include call time durations (e.g., associated with the source device and/or the destination device).

The characteristics may be retrieved from various entities in the telephony network (e.g., network 100). For example, characteristics may be collected from load balancers, inbound SBCs, outbound SBCs, and the like. In some cases, the characteristics may be stored in historical call completion data (e.g., 120 of FIG. 1), and the data ingest layer 210 may have access to the historical call completion data. In some cases, the historical call completion data may be derived from store call data records (CDRs) from the network. In some cases, the entities of the telephony network may provide characteristics as communications, such that each entity may monitor particular characteristics and send the data to the historical call completion data for use by the data ingest layer 210.

The characteristics may also include time periods for reception or collection of the characteristics or call data. For example, each collection of data may include a timestamp for the collection, such as time and date. In other cases, the data ingest layer 210 may provide a timestamp at the time of receiving the data. The time period itself may also be utilized as data, which may be beneficial for implementing a time dependency for a model generated by the configuration 200 (e.g., different times of day may result in different probability values for a call attempt request).

In some cases, the characteristics may be sent to the data ingest layer 210 asynchronously. For example, call data for a call attempt request may be sent to the data ingest layer 210 when the request is received by the telephony network. In some cases the call data may be sent to the data ingest layer 210 when call signaling is received by different entities of the telephony network, such as at an inbound SBC or at an outbound SBC.

In some cases, the characteristics for a call or call request may be sent to the data ingest layer 210 synchronously. For example, the entities in the telephony network may be notified of a collection rate for various call data (e.g., every day, every week, etc.). The network entities may measure or collect the various call data according to the collection rate (or collection rates), and send the data to the data ingest layer 210.

The batch layer 220 may utilize the call data collected by the data ingest layer 210 to generate a trained model for generating probability values associated with whether a call attempt request may result in a completed call, or an estimated number of call attempts to result in a completed call. The batch layer 220 may use machine learning and/or other forms of semantic analysis to assess historical call data (the characteristics received at data ingest layer 210), and provide weights to various call data parameters based on determinations made regarding the devices and call attempts of a telephony network. For example, the batch layer 220 may implement Naïve Bayes Classifier, Support Vector Machine, Linear Regression, Logistic Regression, Artificial Neural Network, Decision Tree, Random Forest, Nearest Neighbor, and the like, as the algorithmic process for generating a model.

For training the model, the batch layer 220 may match call data input parameters to output labels. The batch layer 220 may adjust weights provided to the call data parameters. This process may occur through multiple iterations, to generate a trained model for generating probability values associated whether a call attempt request results in a completed call.

The model may be trained according to the various desired queries. For example, the model may be trained to determine a probability a call attempt request results in a successfully completed call within a particular number of call attempts. In some cases, the model cay be trained to determine a number of attempts for completing a call (e.g., a number of routes 140 of FIG. 1 for completing the call). In some cases, the model may be trained to classify a call attempt request as, for example, likely or unlikely to complete the call.

In some cases, examples from the above may be combined to form an aggregated trained model. For example, scores from the separate initial models may be combined, for example, via averaging, geometric-means, minimal/maximal selection of scores, and the like. Likewise, in some cases, a model may include several, separate models, where a particular model is implemented based on the circumstance.

The trained model may be implemented by the devices or entities (e.g., of the telephony network 100) that implemented the training of the model, for example the voice call filter 115. In other cases, the trained model may be sent to other devices or entities for implementation once trained. For example, if the model is trained on entities or devices in the telephony network 100, the trained model may be sent to the load balancer 105 for implementation and filtering of call attempt requests.

The batch layer 220 may update or adjust a trained model based on call data received after the model is implemented. For example, the batch layer 220 may receive a set of call data for a particular call attempt. The batch layer 220 may receive these call data and associated call results (e.g., number of call attempts, call successful or unsuccessful, and the like) and input the results into the trained model for further training. Thus, the trained model may be updated or adjusted to be more attuned to the corresponding telephony network.

In response to reception of characteristics for a call attempt request, the serving layer 230 may receive or pull results from the trained model (e.g., of the batch layer 220) and generate an output for the configuration 200. For example, the serving layer 230 may query the trained model according to the characteristics associated with the call attempt request. The serving layer 230 may query the trained model for probability values associated with whether the call attempt request may result in a completed call, or an estimated number of call attempts in order to complete the call. The serving layer 230 may send the scores (e.g., probability values corresponding to the call attempt request) to a designated device, such as the load balancer. In some cases, the serving layer 230 may generate a determination for whether or not to forward the call attempt request based on the probability value. For example, the serving layer 230 may compare the probability value to a predefined threshold, and may send the determination to the load balancer (e.g., as an instruction). In some cases, the serving layer 230 may send the probability value to the load balancer for further use.

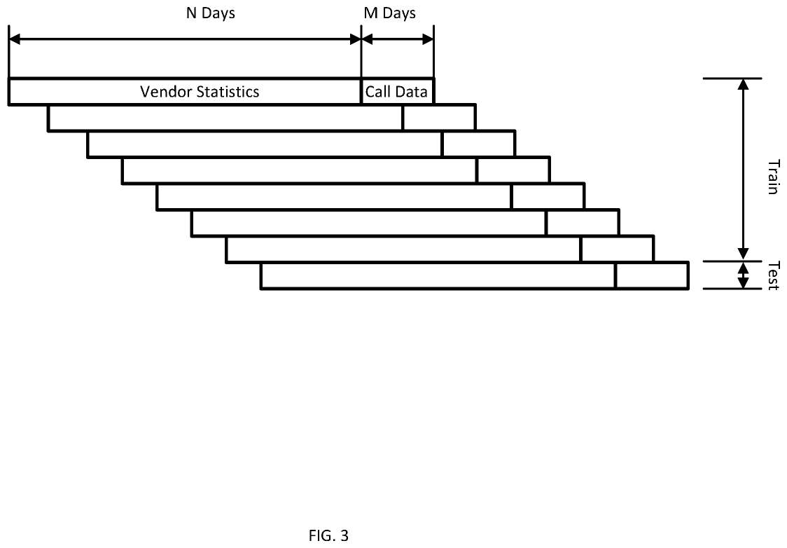

FIG. 3 depicts a data engineering process for training a model. For example, the batch layer 220 of FIG. 2 may train the model according to the data engineered by the process shown in FIG. 3. The voice call filter (e.g., the data ingest layer) may receive vendor statistics 310 (e.g., call and/or network characteristics) pertaining to one or more source and/or destination devices for a given time period (e.g., M) days). The statistics may be aggregated over the given time period and inputted into the batch layer for training. Other call data 315 may be retrieved and inputted for training for another time period (e.g., N days), which may in some cases may remain unaggregated. This process may reiterate for a number of days (e.g., the Training region 320), and the model may then be tested afterwards (e.g., on collected call data and during the Test region 325).

FIG. 4 shows general hardware elements that may be used to implement any of the various systems or computing devices discussed herein. The computing device 400 may include one or more processors 401, which may execute instructions of a computer program to perform any of the features described herein. The instructions may be stored in any type of computer-readable medium or memory, to configure the operation of the processor 401. For example, instructions may be stored in a read-only memory (ROM) 402, random access memory (RAM) 403, removable media 404, such as a Universal Serial Bus (USB) drive, compact disk (CD) or digital versatile disk (DVD), floppy disk drive, or any other desired storage medium. Instructions may also be stored in an attached (or internal) hard drive 405. The computing device 400 may include one or more output devices, such as a display 406 (e.g., an external television), and may include one or more output device controllers 407, such as a video processor. There may also be one or more user input devices 408, such as a remote control, keyboard, mouse, touch screen, microphone, camera input for user gestures, etc. The computing device 400 may also include one or more network interfaces, such as a network input/output (I/O) circuit 409 (e.g., a network card) to communicate with an external network 410 (e.g., over telephony network 100). The network input/output circuit 409 may be a wired interface, wireless interface, or a combination of the two. Additionally, in some examples the device may be configured to implement one or more aspects discussed herein. For example, the device may include a call data store 411, which may be configured to receive, store, and send information regarding call data or measurements taken at the device and/or in the network, and associated context. The call data store 411 may utilize other components of the device, such as hard drive 405, removable media 404, and/or RAM 403.

Further, in some cases, the device 400 may also be configured to store and execute a trained model for generating probability values associated with whether a call attempt request may result in a completed call.

The FIG. 4 example is a hardware configuration, although the shown components may be wholly or partially implemented as software as well. Modifications may be made to add, remove, combine, divide, etc. components of the computing device 400 as desired. Additionally, the components shown may be implemented using basic computing devices and components, and the same components (e.g., processor 401, ROM storage 402, display 406, etc.) may be used to implement any of the other computing devices and components described herein. For example, the various components herein may be implemented using computing devices having components such as a processor executing computer-executable instructions stored on a computer-readable medium, as shown in FIG. 4. Some or all of the entities described herein may be software based, and may co-exist in a common physical platform.

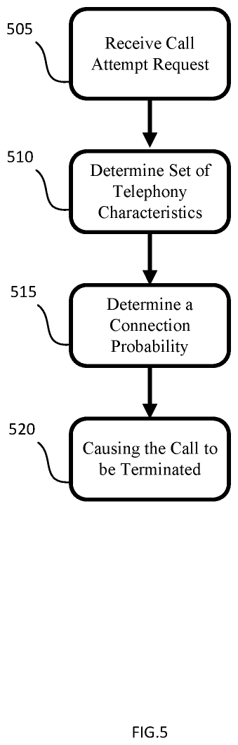

FIG. 5 shows an example method for telephony traffic analysis and resource optimization as discussed herein. The method of FIG. 5 may be implemented in one or more computing devices, such as computing device 400 of FIG. 4. In some cases, the method of FIG. 5 may be implemented by a processor of the one or more computing devices, and executable instructions according to the method may be stored on a memory of the one or more computing devices. The one or more computing devices may be part of a network, such as telephony network 100 of FIG. 1. The shown method may in some cases be performed by one or more computing devices in the network. Although the steps of the method may be described with regard to a computing device, it should be understood that the various steps of the method may be handled by different computing devices without departing from the aspects and features described herein.

At Step 505, a computing device of a telephony network may receive a request to connect a telephony call. In some cases, the computing device may be a load balancer of the telephony network. In some cases, the request may include a SIP call source invite. In some cases, the request may include an identifier of the source device, an identifier of the destination device, or both.

At Step 510, the computing device may determine a set of characteristics associated with the request to connect the telephony call. The set of characteristics may include, for example, the identifier of the source device, the identifier of the destination device, geographical locations of the source device and/or the destination device, time of day, date, weekday or weekend, peak usage time, and the like.

At Step 515, the computing device may determine a probability corresponding to the telephony network successfully completing the request to connect the telephony call. In some cases, the computing device may input the characteristics into a trained model. In some cases, the trained model may be included in a voice call filter. In some cases, the trained model may be configured to output the probability to the computing device. In some cases, the trained model may be trained on call data of the telephony network over a time period. In some cases, the trained model may receive as input other characteristics of the telephony network from other entities.

At Step 520, the computing device may cause the call to be terminated based on the probability falling below a probability threshold. In some cases, the probability value may be compared to the probability threshold which may be a predefined threshold. In some cases, the comparing may be performed by the computing device, or by the trained model. In some cases, the computing device may send a denial or termination message to the source device indicating the refraining. Alternatively, the computing device may forward the request, and associated call signaling further into the telephony network in cases where the probability value exceeds or satisfies the probability threshold. For example, the computing device may forward the request to an inbound SBC to generate a call session for the call attempt.

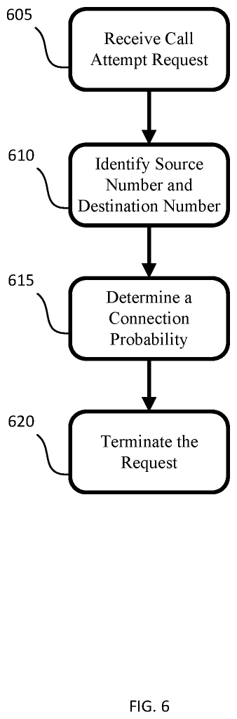

FIG. 6 shows an example method 600 for telephony traffic analysis and resource optimization as discussed herein. The method of FIG. 6 may be implemented in one or more computing devices, such as computing device 400 of FIG. 4. In some cases, the method of FIG. 6 may be implemented by a processor of the one or more computing devices, and executable instructions according to the method may be stored on a memory of the one or more computing devices. The one or more computing devices may be part of a network, such as telephony network 100 of FIG. 1. The shown method may in some cases be performed by one or more computing devices in the network. Although the steps of the method may be described with regard to a computing device, it should be understood that the various steps of the method may be handled by different computing devices without departing from the aspects and features described herein.

At Step 605, a computing device of a telephony network may receive a request to connect a telephony call. In some cases, the computing device may be a load balancer of the telephony network. In some cases, the request may include a SIP call source invite. In some cases, the request may include an identifier of the source device, an identifier of the destination device, or both.

At Step 610, the computing device may identify a source number for the telephony call and a destination number for the telephony call. For example, each number may include a 7 or 10 digit telephony number (e.g., in the format (XXX) XXX-XXXX). In some cases, the source number and the destination number may be included as information of the request to connect the telephony call. In some cases, the computing device may identify other characteristics associated with the call request. For example, the computing device may identify date, time, geographical locations and the like associated with the source device and/or the destination device.

At Step 615, the computing device may determine, based on the source number and the destination number, a probability corresponding to the telephony network successfully completing the telephony call to a live answer or a voicemail. In some cases, the computing device may input the characteristics into a trained model. In some cases, the trained model may be included in a voice call filter. In some cases, the trained model may be configured to output the probability to the computing device. In some cases, the trained model may be trained on call data of the telephony network over a time period. In some cases, the trained model may receive as input other characteristics of the telephony network from other entities. For example, vendor characteristics may be input into the trained model for the determining.

At Step 620, the computing device may terminate the request based on the probability falling below a probability threshold. In some cases, the probability value may be compared to the probability threshold which may be a predefined threshold. In some cases, the comparing may be performed by the computing device, or by the trained model. In some cases, the computing device may send a denial or termination message to the source device indicating the refraining. Alternatively, the computing device may forward the request, and associated call signaling further into the telephony network in cases where the probability value exceeds or satisfies the probability threshold. For example, the computing device may forward the request to an inbound SBC to generate a call session for the call attempt.

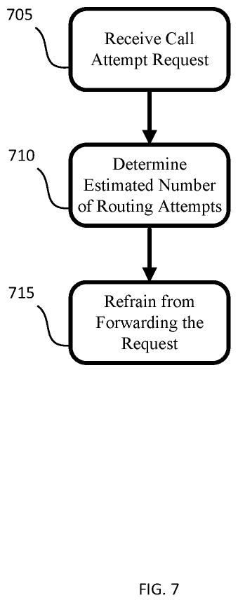

FIG. 7 shows an example method 700 for telephony traffic analysis and resource optimization as discussed herein. The method of FIG. 7 may be implemented in one or more computing devices, such as computing device 400 of FIG. 4. In some cases, the method of FIG. 7 may be implemented by a processor of the one or more computing devices, and executable instructions according to the method may be stored on a memory of the one or more computing devices. The one or more computing devices may be part of a network, such as telephony network 100 of FIG. 1. The shown method may in some cases be performed by one or more computing devices in the network. Although the steps of the method may be described with regard to a computing device, it should be understood that the various steps of the method may be handled by different computing devices without departing from the aspects and features described herein.

At Step 705, a load balancer of a telephony network may receive a request to connect a telephony call. In some cases, the request may include a SIP call source invite. In some cases, the request may include an identifier of the source device, an identifier of the destination device, or both.

At Step 710, the load balancer may determine an estimated number of routing attempts to successfully complete the requested call. In some cases, the load balancer may determine a set of characteristics associated with the request to connect the telephony call. The set of characteristics may include, for example, the identifier of the source device, the identifier of the destination device, geographical locations of the source device and/or the destination device, time of day, date, weekday or weekend, peak usage time, and the like. In some cases, the load balancer may input the characteristics into a trained model. In some cases, the trained model may be included in a voice call filter. In some cases, the trained model may be configured to output the probability to the computing device. In some cases, the trained model may be trained on call data of the telephony network over a time period. In some cases, the trained model may receive as input other characteristics of the telephony network from other entities.

At Step 715, the load balancer may refrain from forwarding the request through the telephony network based on the estimated number of routing attempts exceeding a routing attempt threshold. In some cases, the estimated value may be compared to the routing threshold which may be a predefined threshold. In some cases, the comparing may be performed by the load balancer, or by the trained model. In some cases the refraining from forwarding may include terminating the request. In some cases, the load balancer may send a denial or termination message to the source device indicating the refraining. Alternatively, the load balancer may forward the request, and associated call signaling further into the telephony network in cases where the estimated routing attempt number falls below or does not satisfy the routing attempt threshold. For example, the load balancer may forward the request to an inbound SBC to generate a call session for the call attempt.

Components are described herein that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as determined data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present embodiments may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method, comprising:
receiving, at a computing device of a telephony network, a request to connect a telephony call;
determining, by the computing device, a plurality of characteristics associated with the request to connect the telephony call;
determining, by the computing device, a probability corresponding to the telephony network successfully completing the telephony call; and
causing, by the computing device, based on the probability not satisfying a threshold, the request from being forwarded through the telephony network.

2. The method of claim 1, wherein determining the probability further comprises:
inputting the plurality of characteristics into a trained model; and
receiving as output from the trained model the probability.

3. The method of claim 2, wherein the probability is further based on another plurality of characteristics, comprising historical call data associated with a source device, historical call data associated with a destination device, a set of operating conditions for entities of the telephony network, or a combination thereof.

4. The method of claim 1, wherein the computing device comprises a load balancer.

5. The method of claim 1, wherein the plurality of characteristics comprise a source device identifier, a destination device identifier, a time associated with creation or reception of the request, a date associated with creation or reception of the request, geographical data associated with a source device, geographical data associated with a destination device, or a combination thereof.

6. The method of claim 1, further comprising:
comparing, by the computing device, the probability to the threshold.

7. A method, comprising:
receiving, at a computing device of a telephony network, a request to connect a telephony call;
identifying, by the computing device, a source number for the telephony call and a destination number for the telephony call;
determining, by the computing device and based on the source number and the destination number, a probability of the telephony network successfully completing the telephony call within a quantity of routing attempts; and
causing, by the computing device, based on the probability not satisfying a threshold, the request to connect the telephony call to be terminated.

8. The method of claim 7, wherein determining the probability further comprises:
inputting a set of characteristics into a trained model; and
receiving as output from the trained model the probability.

9. The method of claim 8, wherein the probability is further based on another set of characteristics, comprising historical call data associated with a source device, historical call data associated with a destination device, a set of operating conditions for entities of the telephony network, or a combination thereof.

10. The method of claim 7, wherein the computing device comprises a load balancer.

11. The method of claim 7, wherein the determining the probability is further based, a time associated with creation or reception of the request, a date associated with creation or reception of the request, geographical data associated with a source device, geographical data associated with a destination device, or a combination thereof.

12. The method of claim 7, further comprising:
comparing, by the computing device, the probability to the threshold.

13. A method, comprising:
receiving, at a computing device of a telephony network, a request to connect a telephony call;
determining, by the computing device, an estimated number of routing attempts to successfully complete the requested call; and
causing, by the computing device, based on the estimated number of routing attempts exceeding a threshold, the request to connect the telephony call to be terminated.

14. The method of claim 13, wherein determining the estimated number of routing attempts further comprises:
inputting a set of characteristics associated with the request into a trained model; and
receiving as output from the trained model the estimated number of routing attempts.

15. The method of claim 14, wherein the estimated number of routing attempts is further based on another set of characteristics, comprising historical call data associated with a source device, historical call data associated with a destination device, a set of operating conditions for entities of the telephony network, or a combination thereof.

16. The method of claim 14, wherein the set of characteristics comprise a source device identifier, a destination device identifier, a time associated with creation or reception of the request, a date associated with creation or reception of the request, geographical data associated with a source device, geographical data associated with a destination device, or a combination thereof.

17. The method of claim 13, further comprising:
comparing, by the computing device, the estimated number of routing attempts to the threshold.

18. The method of claim 13, wherein causing the request to be terminated comprises refraining from forwarding the request to any session border controller (SBC) of the telephony network.

19. The method of claim 13, further comprising:
transmitting a denial message to a source device indicative of the termination.

20. The method of claim 1, wherein the threshold is based on current operating conditions of the telephony network.
